(19) United States
(12) Patent Application Publication
(10) Pub. No.: US 2017/0021357 A1
(43) Pub. Date: Jan. 26, 2017

(54) Roller and Replaceable Surface Segments for Roller

(71) Applicant: Cast Steel Products LP, By Its General Partner Cast Steel Products GP Ltd., Edmonton (CA)

(72) Inventors: Dustin Birtch, Edmonton (CA); John Mcintyre, Edmonton (CA); Nick Meeboer, Edmonton (CA)

(21) Appl. No.: 15/190,788

(22) Filed: Jun. 23, 2016

Related U.S. Application Data
(63) Continuation of application No. PCT/CA2015/050122, filed on Feb. 18, 2015.
(60) Provisional application No. 61/941,746, filed on Feb. 19, 2014.
(60) Provisional application No. 62/076,117, filed on Nov. 6, 2014.

(51) Int. Cl. B02C 4/30

(52) U.S. Cl. CPC B02C 4/305; B02C 2210/02

(57) ABSTRACT

The present invention relates to rollers subjected to wear conditions and surface reinforcements for such rollers. More specifically, the present invention relates to the orientation of projections on the rollers or surface segments of such rollers. In one embodiment, the roller includes a hub. The roller also includes a plurality of removable surface segments attachable to the hub so as to form a layer around the hub. Each surface segment has two opposed sides and an exterior surface. The spacing between projections across the exterior surface decreases from each of the opposed sides to an intermediate point between the opposed sides.

### RELATED APPLICATIONS

This application is a continuation of International App. No. PCT/CA2015/050122 entitled “ROLLER AND REPLACEABLE SURFACE SEGMENTS FOR ROLLER” filed on Feb. 18, 2015; which claims priority on U.S. App. No. 61/941,746 entitled “ROLLER AND REPLACEABLE SURFACE SEGMENTS FOR ROLLER” filed on Feb. 19, 2014, and U.S. App. No. 62/076,117 entitled “SEGMENTED ROLLER AND METHOD OF RECONDITIONING SAME” filed on Nov. 6, 2014, all of which are incorporated by reference herein in their entirety.

### TECHNICAL FIELD

The present invention relates to rollers subjected to wear conditions and surface reinforcements for such rollers. More specifically, the present invention relates to the orientation of surface studs on the rollers or surface segments of such rollers.

### BACKGROUND

Friction-based rollers are common components of many machines. A frequent problem with such rollers is wear on the roller surface over time, particularly if the roller is subjected to large frictional forces. When the surface of the roller begins to wear out or becomes uneven, the roller must then be replaced or the surface of the roller must be remanufactured in some way.

Frictional wear is particularly problematic for industrial rollers used to crush, compact, shred, or grind materials. Industrial rollers are used extensively in mining operations to break up rock, ore, and other brittle materials into smaller particles. Industrial rollers can also be used for trash compaction or in other applications where high throughput crushing, shredding, or compaction is required. Two basic types of industrial rollers are commonly used; the first being a single roller operating adjacent to a stationary curved anvil plate and the second being a double counter-rotating set of rollers having parallel axes and a gap between the rollers.

Particle output size from a roller or pair of rollers is determined by the size of the gap, also known as the ‘nip’, between the roller surface and the opposing surface, such as an anvil plate or opposing roller. Material is drawn into the nip by the rotating motion of the roller surface and exits the nip in a continuing stream of crushed, compacted, or shredded material.

In many industrial applications, particularly in the mining industry, industrial rollers are subjected to extremely high pressures and/or are used to crush relatively hard materials, both of which can result in significant frictional wear on the rollers. A common symptom of such wear is known as ‘dishing’, in which the surface of the roller develops a concave profile over time. Wear patterns tend to be most pronounced at the centre of the outer surface of the roller and progressively decrease between the centre of the outer surface of the roller and the both edges of the outer surface of the roller. The resulting unevenness in the roller surface can be problematic as it varies the effective size of the nip across the axial length of the roll and the particulate size of the material output by the roller varies accordingly.

One conventional approach to extending the life of an industrial roller is to reinforce the roller surface with extremely hard materials, such as tungsten carbide. In view of the higher costs of such materials, an outer shell is often applied over an inner drum, rather than manufacturing the entire roller out of the (more expensive) harder material. Nevertheless, even the hardest materials will wear out over time and so this approach can only extend the time required before the roller must be replaced or remanufactured in order to provide an even surface.

Industrial rollers also often have surface features such as teeth, blades, or studs that assist the roll surface in directing material into the nip and also assist with the crushing or shredding action of the roller. Depressions or grooves on the roller surface can also be used to retain milled material on the roller surface, as a means of reducing wear on the roller surface. However, like the roller surface itself, surface features also wear out over time due to friction, even if they are constructed from relatively hard materials.

Conventional crushing rollers used in the mining industry use an array of tungsten carbide studs as a surface reinforcement. The carbide studs are inserted into a plurality of holes distributed across the surface of the roller and the studs are typically welded in place. Thus the positioning of the holes dictates the positioning of the studs upon the roller. In operation, the studs act as teeth to assist in the grinding action and the spaces between the studs retain milled material and so protect the underlying roller surface from wear. Over time, the studs wear out, often in an uneven manner, and the underlying roller surface can also be subjected to uneven wear.

When an industrial roller reaches the end of its service life, it must be replaced or remanufactured. In many applications, particularly in the mining industry, industrial rollers can be quite large and so remanufacture is often preferred over complete replacement of the roller.

The remanufacture of a worn roller is not a simple or inexpensive task, involving removal of the entire drum from service, followed by extensive cutting, machining, and rewelding of the surface of the drum.

For rollers in the mining industry that rely on carbide studs, it is not uncommon to cut off the studs using a lathe and begin the painstaking process of installing new studs on the roller surface. For example, U.S. Pat. No. 8,316,543 to Patzelt et al. describes one process in which the surface of the roller is machined and the reconditioned surface is built back up using a welding process to deposit new surface material. New holes are then drilled in the rebuilt surface and new studs are set into place. U.S. Patent Application No. 2012/0138722 A1 by Brendler describes a similar approach, in which surface features on the worn roller are cut off, a radial groove is machined into the reconditioned roller surface, new features are set into either side of the groove, and a form fitting body is inserted between the features to fill in the machined groove and hold the features in place.

As can be understood by the person of skill in the art, methods which rely on turning or machining an industrial roller will result in a reduction in the diameter of the remanufactured roller, unless new material is welded onto the surface to replace the material lost during the reconditioning process. For industrial rollers which employ studs, conventional methods require a new array of receiving holes to be drilled on the roller surface.

Regardless of the method used during remanufacture, the need for secure attachment of the surface reinforcements to the roller drum and the reliance in the art on welding for attaching features to the roller surface makes remanufacture of worn out rollers difficult, expensive, and labour intensive.

### SUMMARY OF THE INVENTION

It is an object of the present invention to provide an improved roller incorporating projections that will limit frictional wear upon the roller's outer surface.

In the present invention, projections are orientated on the surface of the roller to limit the wear upon the surface of the roller.

In the present invention, projections are orientated on the surface of the roller to limit the wear upon the central surface of the roller.

Accordingly, a reinforced roller is provided in one preferred embodiment. The roller has two side edges and a median line between the side edges. The roller also has an outer surface between the side edges incorporating adjacent surface features. The adjacent surface features are each separated by a distance wherein the distance between a first set of two adjacent surface features proximate to one of the side edges exceeds the distance between a second set of two adjacent surface features proximate to the median line.

In another embodiment, the reinforced roller includes an inner roll. The reinforced roller also includes a plurality of removable outer segments attachable to the inner roll so as to form a layer around the inner roll. Each outer segment has two side edges, a median line between the side edges and an outer segment surface between the side edges. Adjacent surface features projecting above the outer segment surface are each separated by a distance wherein the distance between a first set of two adjacent surface features proximate to one of the side edges exceeds the distance between a second set of two adjacent surface features proximate to the median line.

In another embodiment there is provided a roller for crushing, grinding, or otherwise contacting a material, the roller comprising:
a cylindrical body rotatable about a central axis, the body comprising:
a first and second opposed ends; and
a working surface disposed between the opposed sides, the working surface comprising:
a plurality of projections for crushing, grinding, or otherwise contacting a material, wherein the spacing of the projections across the working surface decreases from each of the opposed sides to an intermediate point between the opposed ends.

In another embodiment there is provided a roller assembly for crushing, grinding, or otherwise contacting a material, the assembly comprising:
a hub configured for mounting to an axle, said hub rotating about a central axis and having an outer surface comprising one or more engagement structures, and;
a plurality of surface segments configured for attaching to said one or more engagement structures of said hub, said segments each comprising:
   an exterior surface for contacting material at a working surface of the roller assembly;
   an interior surface opposed to said exterior surface configured to engage an engagement structure disposed on the outer surface of the hub, thereby covering at least a portion of the outer surface of the hub;
   a leading edge and a trailing edge joining the exterior surface to the interior surface;
   a first and second opposed sides joining the outer surface to the inner surface; and
   a plurality of projections for crushing, grinding, or otherwise contacting a material, wherein the spacing of the projections across the exterior surface decreases from each of the opposed sides to an intermediate point between the opposed sides.

In another embodiment there is provided a roller assembly for crushing, grinding, or otherwise contacting a material, the assembly comprising:
a hub configured for mounting to an axle, said hub having an outer surface comprising one or more engagement structures; and
a plurality of surface segments configured for attaching to said one or more engagement structures of said hub, said segments each comprising:
   an exterior surface for contacting material at a working surface of the roller assembly;
   an interior surface opposed to said exterior surface of the surface segment configured to engage an engagement structure disposed on the outer surface of the hub, thereby covering at least a portion of the outer surface of the hub;
   a leading edge and a trailing edge joining the outer surface to the inner surface;
   a first and second opposed sides joining the outer surface to the inner surface; and
   a plurality of projections for crushing, grinding, or otherwise contacting a material, wherein the spacing of the plurality of projections across the exterior surface decreases from each of the edges to an intermediate point between the between the edges.

In another embodiment there is provided a surface segment comprising:
an exterior surface for contacting material at a working surface of the roller assembly;
an interior surface opposed to said exterior surface configured to engage an engagement structure disposed on the outer surface of the hub, thereby covering at least a portion of the outer surface of the hub;
a leading edge and a trailing edge joining the exterior surface to the interior surface;
a first and second opposed sides joining the outer surface to the inner surface; and
a plurality of projections for crushing, grinding, or otherwise contacting a material, wherein the spacing of the projections across the exterior surface decreases from each of the opposed sides to an intermediate point between the opposed sides.

### BRIEF DESCRIPTION OF THE DRAWINGS

The invention will now be described with reference to the attached drawings, which illustrate, by way of example only, embodiments of the invention contemplated herein:

FIG. 1 is a perspective view of the roller according to one embodiment of the invention;

FIG. 2 is a perspective view of one surface segment fastened to the axle and hub according to one embodiment of the invention;

FIGS. 3A and 3B are perspective views of the axle (FIG. 3A), and inner roll or hub (FIG. 3B);

FIG. 4 is a perspective view of a surface segment of the roller shown in FIG. 2;

FIG. 5 is a top view of a surface segment according to one embodiment of the invention;

FIG. 6 is a side view of the surface segment shown in FIG. 5;

FIG. 7 is an additional side view of a surface segment according to one embodiment of the invention;

FIGS. 7A and 7B are sectional views of the surface segment along lines G-G and H-H, respectively, from FIG. 7;

FIG. 8 is a further top view of the surface segment according to one embodiment of the invention;

FIGS. 8A to 8D are sectional views of the surface segment along lines A-A, B-B, C-C and D-D, respectively, from FIG. 8;

FIGS. 8E and 8F are detailed views of portions E and F of the surface segment, respectively, from FIG. 8;

FIG. 9 is a further top view of a surface segment according to one embodiment of the invention; and

FIG. 9A is a detailed view of portion M of the surface segment from FIG. 9.

### DETAILED DESCRIPTION

Referring to the drawings, various embodiments of the invention will now be disclosed.

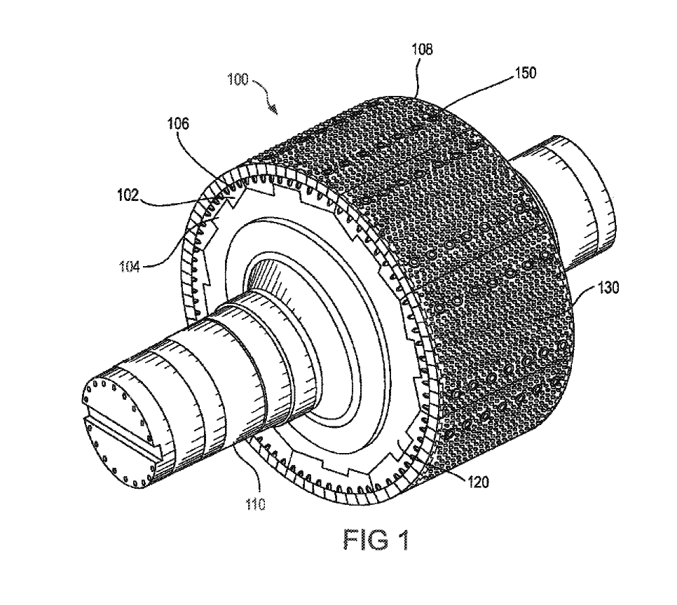

Referring to FIG. 1, the roller 100 is in general terms a cylindrical body 102 rotatable about a central axis, the body 102 having a working surface 104 for crushing, grinding, shredding, rolling, or otherwise contacting a material (not shown) and a first and second opposed ends (106, 108).

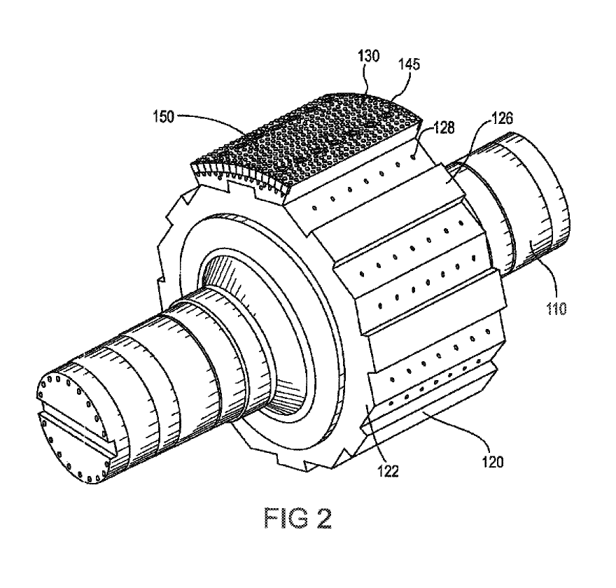

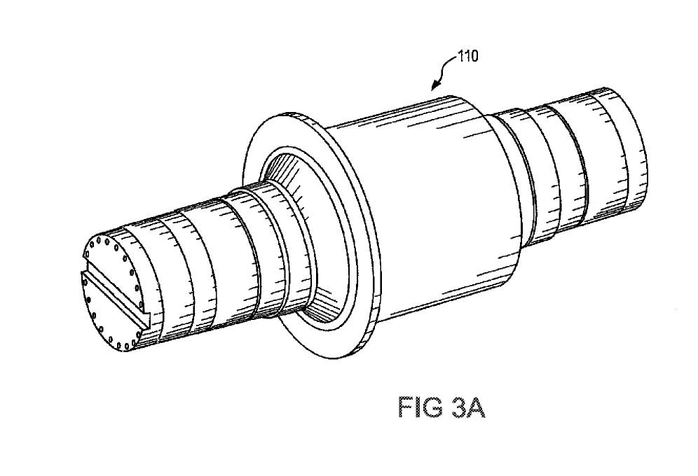

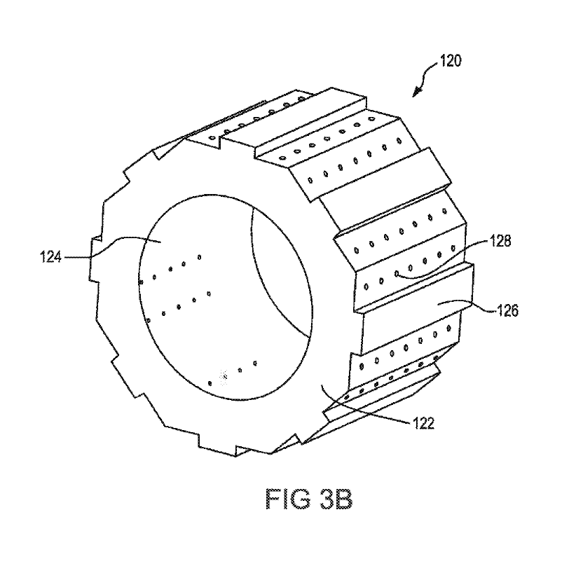

Referring to FIG. 1, FIG. 2, and FIGS. 3A and 3B, Roller 100 comprises a central hub 120 and a plurality of surface segments 130 which will be discussed in more detail below. Turning to FIGS. 3A and 3B, hub 120 has an outer surface 122 and a central bore 124. Roller 100 can be mounted on an axle 110 through bore 124, whereby rotation of shaft 110 drives roller 100. Shaft 110 can be rotatably driven by any drive or drive mechanism (not shown) known in the art suitable for driving a roller assembly 100 of the type disclosed herein. Further mechanical components may also be provided as appropriate, such as a gearbox, emergency disconnect and other known components, not shown but conventional.

Referring to FIGS. 1 to 4, the plurality of surface segments 130 are mounted to the outer surface 122 of hub 120. The surface segments 130 form some, substantially all, or all, of the working surface 104 of the roller 100. In a preferred embodiment, each of the surface segments 130 has an arcuate form such that the placement of a plurality of surface segments 130 on the hub 120 results in a substantially cylindrical working surface for the roller 100. In a preferred embodiment, eight surface segments 130 are disposed upon the hub 120. Each surface segment 130 is disposed as closely as possible to adjacent surface segments 130, preferably at a gap of 0.25 millimeters apart.

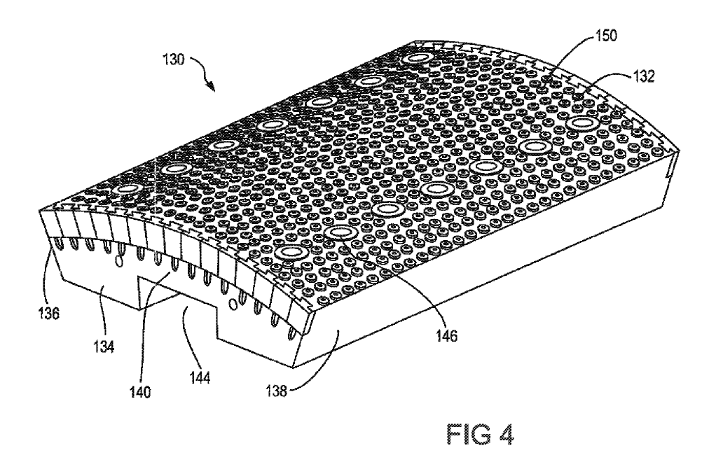

Referring to FIGS. 4, 5, 6, and 7, it will be understood that each surface segment 130 has an exterior surface 132 for contacting material at a working surface 104 of the roller 100. Opposed to the exterior surface 132 is an interior surface 134 for engagement with hub 120. The exterior surface 132 and the interior surface 134 of the surface segment 130 are joined together by a leading edge 136 and a trailing edge 138. When the surface segments 130 are assembled to form the roller 100, and the roller 100 is made to roll, the leading edge 136 is to be understood as the portion of the surface segment 130 that leads in the direction of rotation and the trailing edge 138 is that portion of the surface segment 130 that trails behind the leading edge 136. As mentioned above, surface segment 130 has an arcuate form, and in an embodiment, the angle θ subtended by the leading edge 136 and the trailing edge 138 is about 45 degrees.

Again, with reference to FIGS. 4, 5, 6, and 7, the exterior surface 132 and the interior surface 134 of the surface segment 130 are also joined together by opposed first side 140 and second side 142. It will be understood that when the surface segments 130 are assembled to form the roller 100, the opposed first 140 and second sides 142, form portions of the opposed first ends 106 and second ends 108 of the cylindrical body 102.

The interior surface 134 of the surface segment 130 will now be described in detail with reference to FIG. 2, FIG. 3B, and FIG. 4. Surface segments 130 can be engaged to the hub 120 at engagement structures 126, 144. In FIGS. 2 and 3B, the engagement structures 126, 144 are provided as a male member, in this case a rectangular ridge 126, on the outer surface 122 of the hub 120, which interlocks with a corresponding female member, in the case a rectangular groove 144, on the interior surface 134 (i.e. the underside) of surface segment 130. The ridge 126 extends radially outwards from the hub 120 and along the axial length of the roller 100, parallel to its central axis. The ridge 126 is received in a corresponding groove 144 on the interior surface 134 of the surface segment 130, thereby providing stability to the surface segment 130 when the roller 100 is in motion, particularly with regard to torsional forces.

As depicted in FIG. 2 and FIG. 3B, the engagement structures 126, 144 have an interlocking rectangular profile. Alternative interlocking structures are also contemplated, including dovetailed, T-shaped, or similar profiles which limit movement of the surface segment 130 in the radial direction. Similarly, arrangements in which the male member is provided on the surface segment 130 and the female member is provided on the hub 120 are also contemplated.

FIG. 2 depicts a surface segment 130 fastened to hub 120. In this example, the connection between the male and female members at the engagement structures 126, 144 is secured by a plurality of bolts 145, which pass through corresponding bolt holes 146 in the surface segment 130 and secures into a corresponding threaded hub hole 128 in the outer surface 122 of the hub 120. Likewise, although FIG. 3B depicts fastening of the surface segments 130 in a radial direction, fastening is also contemplated in an axial direction, particularly where the engagement structures interlock using a profile which prevents movement in the radial direction.

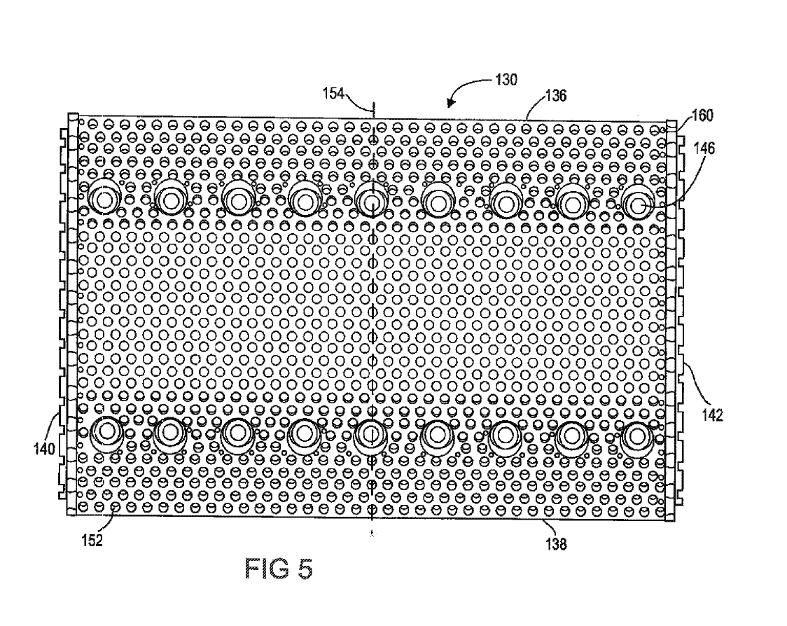

The number of bolt holes 146 in surface segment 130 can vary, as can the pattern in which the bolt holes 146 appear upon the surface segment 130. In embodiments, the bolt holes 146 are aligned in two parallel rows of nine bolt holes 146 as shown in FIG. 5, or the bolt holes 146 are aligned in two parallel rows of seven bolt holes 146 as shown in FIGS. 1, 2, and 4. Various other means of fastening known in the art are also contemplated, such as heat releasable glues, metal screws, heat shrinking and the like.

The exterior surface 132 of the surface segment 130 will now be described in detail with reference to FIG. 4, and FIG. 5. Referring to FIG. 4, the surface segment 130 incorporates a plurality of projections 150 for crushing, grinding, or otherwise contacting a material. Projections 150 can be studs, pins, blades, teeth or any other protrusion that projects above the exterior surface 132 of the surface segment 130. The total number of projections 150 may vary depending on the needs and the desired size of the surface segment 130, and thus roller 100.

Projections 150 project outwardly from the working surface 104 of the roller 100 to crush, grind, or otherwise contact a material. In an embodiment, the projections 150 project radially outward from exterior surface 132 of the surface segment 130. In a preferred embodiment, the projections 150 form rows aligned with the central axis and each row spans from the first side 140 to the second side 142. In another preferred embodiment, the projections 150 of one row are offset with the projections 150 of adjacent rows in a pattern as depicted more clearly in FIGS. 4 and 5.

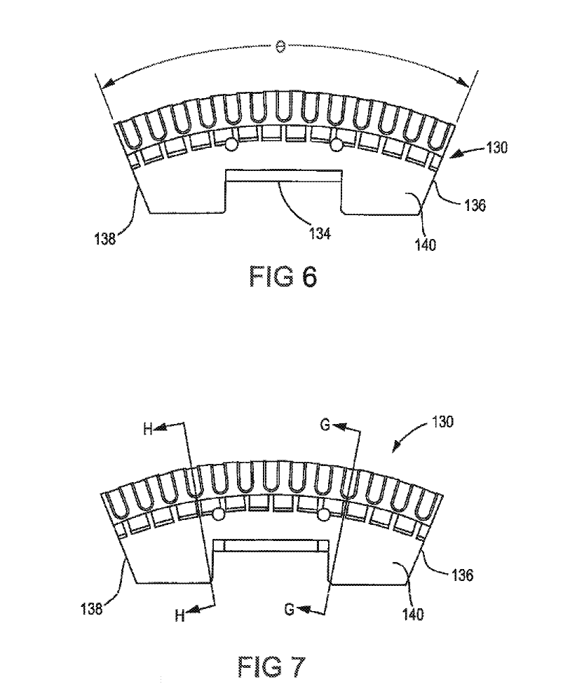

FIG. 5 is a top view of one surface segment 130, and FIG. 6 is a side view of the first side 140 of the surface segment 130 for a roller 100 in isolation. The surface segment 130 is shown without projections 150, for illustration purposes. Instead, surface segment 130 is shown having a plurality of apertures 152 bored into the working surface of the surface segment 130. In the embodiment shown in FIG. 5, the apertures 152 are substantially circular and have similar diameters (distances shown in the figures are in millimeters). It will be understood that apertures 152 are dimensioned to receive and solidly fix corresponding projections 150. The projections 150 are affixed within the apertures 152 by conventional means known in the art, whether by welding, the use of an adhesive or the like.

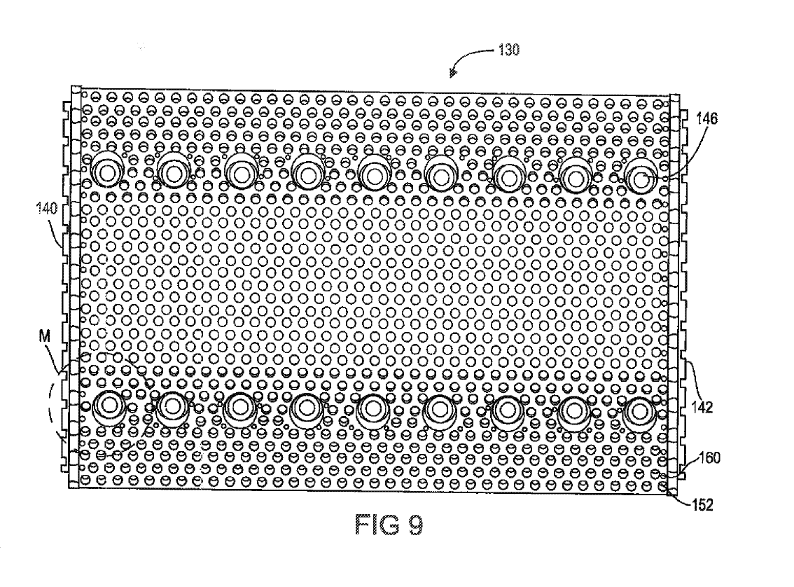

The distribution profile of the apertures 152 on the surface segment 130 will now be discussed in greater detail with reference to FIGS. 5 to 9A. For convenience, it may be understood that each surface segment 130 also has an intermediate point 154 along a line drawn parallel to the central axis of the roller 100 between the first side 140 and the second side 142 as depicted in FIG. 5. The intermediate point 154 is not a feature visible upon the surface segment 130 but is used herein merely as reference. Preferably the intermediate point 154 is the midpoint between on a line drawn parallel to the central axis between the first side 140 and the second side 142.

As depicted in FIG. 5, the apertures 152 form a plurality of rows where each row is aligned parallel to the central axis and each row spans the first 140 and second 142 opposed sides. Reference will now be made to Table 1 below which provides an example of the distribution profile of the apertures 152 on the surface segment 130. In Table 1, the left and right columns represent the bottom and the top row of apertures 152, respectively, of the surface segment 130 of FIG. 5. The values from top to the bottom of each column represent the distances (in mm) that each of the apertures 152 are from the first side 140 along that particular row. It follows that the values at the top of each column are most proximate to the first side 140 and the values at the bottom of each column are most proximate to the second side 142.

TABLE 1

| Bottom Row | Top Row |
|---|---|
| 0 | 0 |
| 36 | 33* |
| 66 | 51 |
| 95.78 | 80.89 |
| 125.35 | 110.57 |
| 154.70 | 140.03 |
| 183.84 | 169.27 |
| 212.76 | 198.30 |
| 241.46 | 227.11 |
| 269.95 | 255.71 |
| 298.22 | 284.09 |
| 326.28 | 312.25 |
| 354.12 | 340.20 |
| 381.74 | 367.93 |
| 409.15 | 395.44 |
| 436.34 | 422.74 |
| 463.31 | 449.83 |
| 490.07 | 476.69 |
| 516.62 | 503.35 |
| 542.94 | 529.78 |
| 569.06 | 556 |
| 595.38 | 582.22 |
| 621.93 | 608.65 |
| 648.69 | 635.31 |
| 675.66 | 662.17 |
| 702.85 | 689.26 |
| 730.26 | 716.56 |
| 757.88 | 744.07 |
| 785.72 | 771.80 |
| 813.78 | 799.75 |
| 842.05 | 827.91 |
| 870.54 | 856.29 |
| 899.24 | 884.89 |
| 928.16 | 913.70 |
| 957.30 | 942.73 |
| 986.65 | 971.97 |
| 1016.22 | 1001.43 |
| 1046 | 1031.11 |
| 1076 | 1061 |
| | 1079* |

From Table 1 above, it will be understood generally that within one row, the placement of apertures 152 across the working surface is such that the spacing between adjacent apertures 152 decreases from each of the opposed sides 140, 142 to the intermediate point 154 between the opposed sides. In this example, the spacing between adjacent apertures 152 most proximate to either the first 140 or second 142 opposed sides is about 30 mm. The spacing between adjacent apertures 152 progressively decreases during the progression from the first 140 or second 142 opposed sides towards the midpoint. In the region most proximate to the midpoint, the spacing between adjacent apertures 152 is reduced to about 26 mm. Numbers marked with an asterisk (*) represent a relatively small number of apertures 160 having a reduced diameter that are included to accommodate for an irregular surface area imposed by the selection of an offset pattern of rows of apertures 152 in this example.

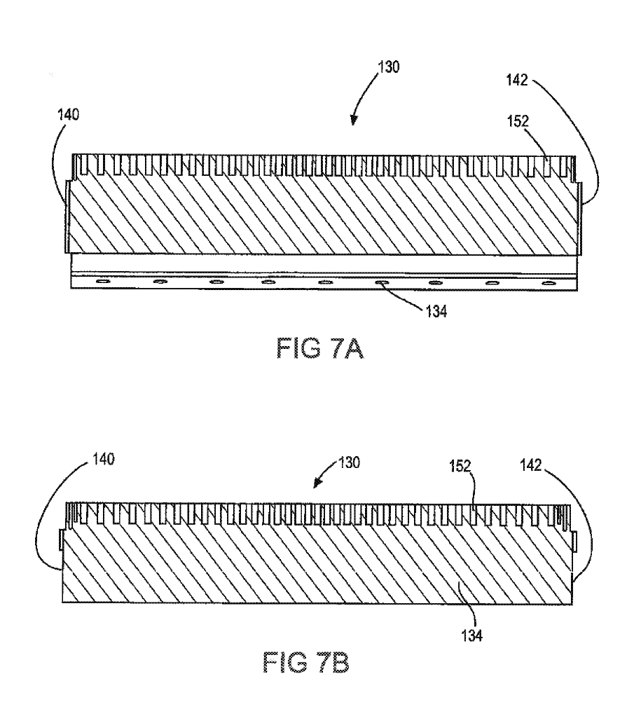

To differently illustrate the placement of the apertures 152 across working surface, reference will now be made to FIGS. 7, 7A and 7B. FIG. 7 depicts another side view of the first side of the surface segment 130 and FIGS. 7A and 7B are sectional views of the surface segment 130 along lines G-G and H-H of FIG. 7. As seen in FIGS. 7A and 7B, within a row as defined by lines G-G or H-H, respectively, the spacing between adjacent apertures 152 most proximate the first and second opposed sides 140, 142 is greater than the spacing between adjacent apertures 152 most proximate the intermediate point 154 between the first 140 and second 142 opposed sides.

The values listed in Table 1 are meant as examples. Persons skilled in the art will understand that range of distances are contemplated. For example, the distance between a set of adjacent apertures 152 most proximate to either the first side 140 or the second side 142 is within a range between 28 millimeters and 32 millimeters and the distance between a set of two adjacent apertures 152 most proximate to the midpoint of the surface segment 130 is within a range between 25 millimeters and 27 millimeters. In a further example, the distance between a set of two adjacent apertures 152 most proximate to either the first side 140 or the second side 142 of the surface segment 130 is 30 millimeters and the distance between a set of two adjacent apertures 152 most proximate to the midpoint of the surface segment 130 is 26.32 millimeters.

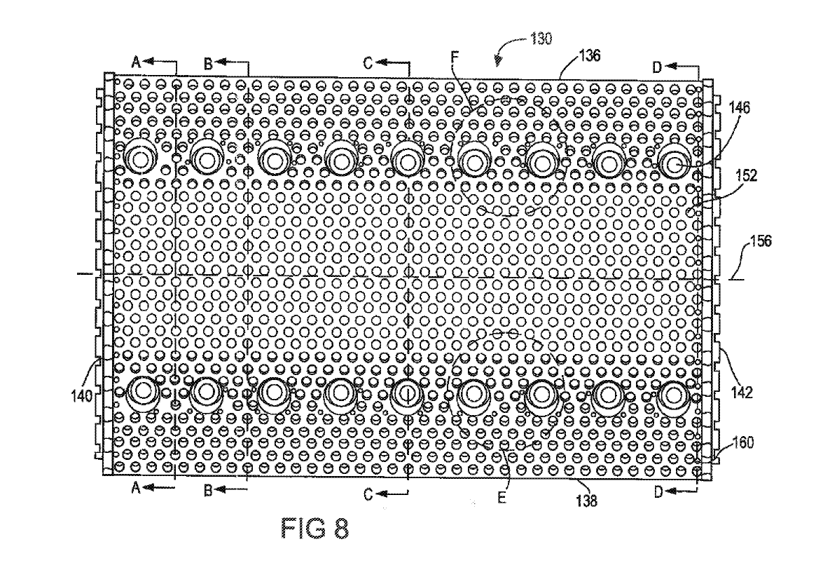

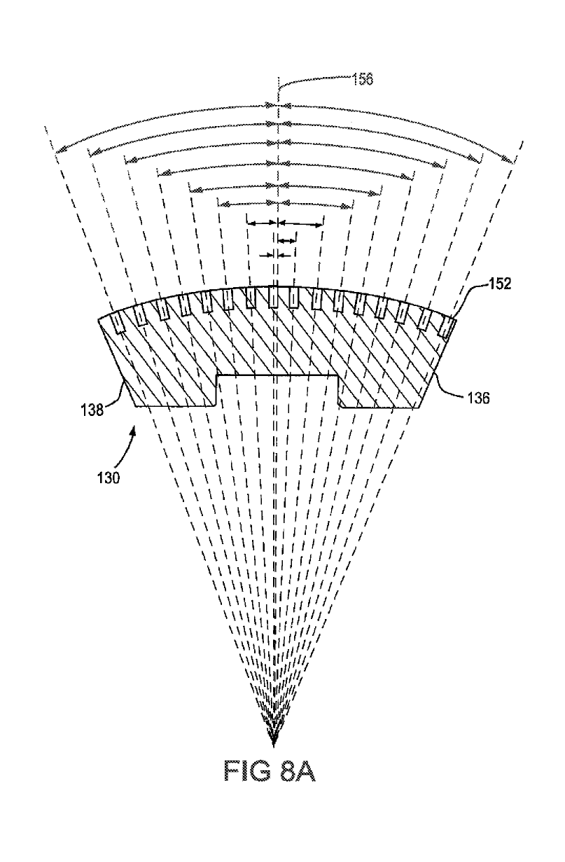

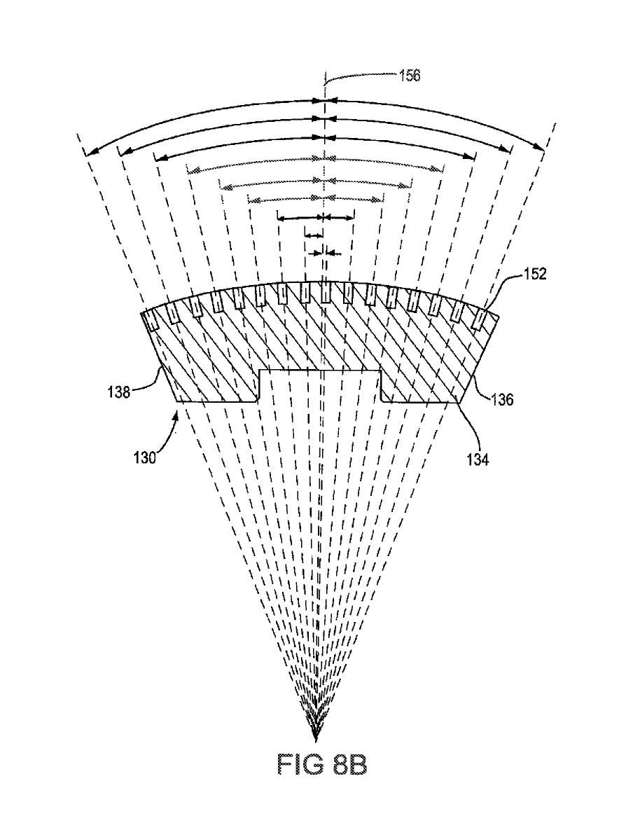

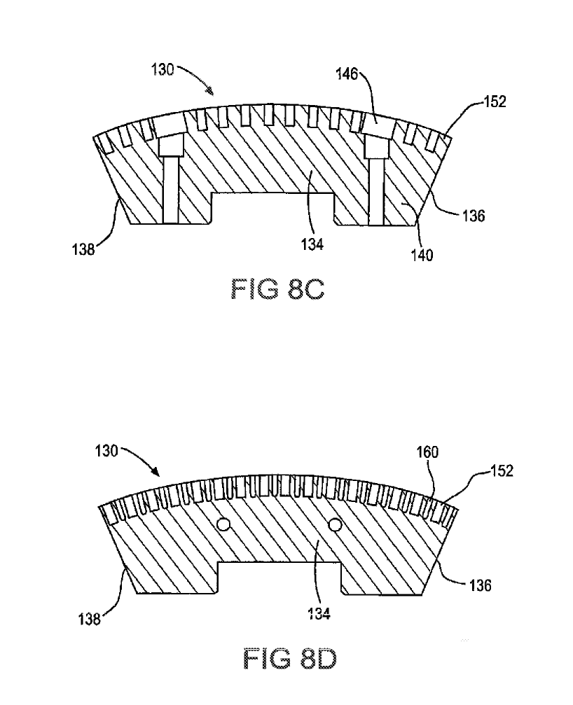

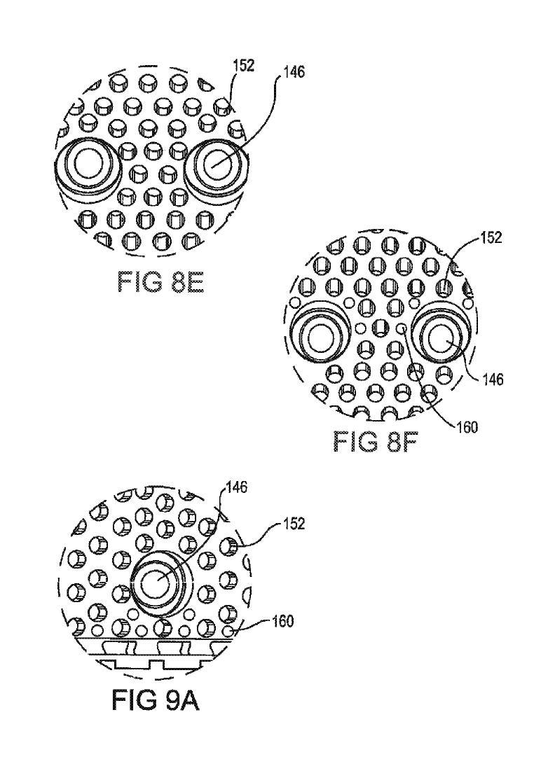

In yet a further embodiment, the distribution profile of apertures 152 on the surface segment 130 can also take a form that will now be described with reference to FIGS. 8, and 8A-8D. FIG. 8 depicts another side view of the first side of the surface segment 130 and FIGS. 8A-8D are sectional views of the surface segment 130 along lines A-A, B-B, C-C, and D-D of FIG. 8, respectively. For convenience, it may be understood that each surface segment 130 has an intermediate point 156 between the leading edge 136 and the trailing edge 138. This intermediate point 156 between the leading edge 136 and the trailing edge 138 can be understood to divide the surface segment 130 into 2 halves as depicted in FIG. 8. The intermediate point 156 is not a feature visible upon the surface segment 130 but is used herein merely as reference. Preferably the intermediate point 156 is the midpoint between the leading edge 136 and the trailing edge 138.

With reference to FIGS. 8A and 8B, along each row of apertures 152 defined by lines A-A or B-B, each aperture 152 can be understood as subtending an angle in relation to the intermediate point 156 or any other aperture 152. As shown in FIGS. 8A and 8B, the angle subtended between adjacent apertures 152 most proximate to at least one of the edges 136, 138 is greater than the angle subtended between adjacent apertures 152 most proximate to an intermediate point 156 between the edges 136, 138. The result is that the spacing between adjacent apertures 152 most proximate to either the leading edge 136 or trailing edge 138 is greater than the spacing between adjacent apertures 152 most proximate the intermediate point 156 between the leading edges 136 and trailing edges 138.

Reference will now be made to Table 2 below which provides an example of the distribution profile of the apertures 152 on the surface segment 130 as depicted in FIG. 8A. In Table 2, there are 16 apertures 152 where aperture No. 1 is closest to the trailing edge 138 and the aperture No. 16 is closest to the leading edge 136 of the surface segment 130. The right column lists the angle that each of the apertures 152 subtends with the midpoint between the leading edge 136 and the trailing edge 138.

TABLE 2

| Aperture No. | Degrees from Midpoint |
|---|---|
| 1 | 20.21 |
| 2 | 17.42 |
| 3 | 14.63 |
| 4 | 11.85 |
| 5 | 9.06 |
| 6 | 6.27 |
| 7 | 3.48 |
| 8 | .70 |
| 9 | 2.09 |
| 10 | 4.88 |
| 11 | 7.66 |
| 12 | 10.45 |
| 13 | 13.24 |
| 14 | 16.02 |
| 15 | 18.81 |
| 16 | 21.60 |

Reference will now be made to Table 3 below which provides an example of the distribution profile of the apertures 152 on the surface segment 130 as depicted in FIG. 8B. Similar to the Table 2, in Table 3, there are 16 apertures 152 where aperture No. 1 is closest to the trailing edge 138 and aperture No. 16 is closest to the leading edge 136 of the surface segment 130. The right column lists the angle that each of the apertures 152 subtends with the midpoint between the leading edge 136 and the trailing edge 138.

TABLE 3

| Aperture No. | Degrees from Midpoint |
|---|---|
| 1 | 21.60 |
| 2 | 18.81 |
| 3 | 16.02 |
| 4 | 13.24 |
| 5 | 10.45 |
| 6 | 7.66 |
| 7 | 4.88 |
| 8 | 2.09 |
| 9 | 0.70 |
| 10 | 3.48 |
| 11 | 6.27 |
| 12 | 9.06 |
| 13 | 11.84 |
| 14 | 14.63 |
| 15 | 17.42 |
| 16 | 20.21 |

In one embodiment, a first angle subtended between adjacent projections 150 proximate to at least one of the edges 136, 138 is 0.01 degrees greater than a second angle subtended between adjacent projections 150 proximate to intermediate point 156 between the edges 136, 138.

The surface segment 130, and thus roller 100, may have any dimension known by those skilled in the art suitable for crushing, grinding, or otherwise contacting a material. The total number of projections 150 formed on the surface segment 130 can vary depending on the desired size of the surface segment 130, and thus the roller 100.

Projections 150 may have any desired height or diameter. With reference to FIGS. 1, 4, 5, 7, 7A-7B, 8, 8A-8F, 9, and 9A, while the majority of protrusions 150, and thus apertures 152, are of similar diameter across the working surface of the roller 100, it will be understood that a relatively small number of protrusions 150, thus apertures 152, may have slightly smaller diameters, such as for example apertures 160 and/or different spacing between apertures 152 and 160 to accommodate for other structures. In particular, as shown in FIGS. 5, 7, 7A-7B, 8, 8A-8F, 9, and 9A, apertures 160 located proximate to the first 140 or second sides 142, or between bolt holes 146, or between the bolt holes 146 and the first 140 or second sides 142 may have a different sized diameters and spacing than that for the majority of the protrusions 150 and apertures 152 shown, for example, in FIGS. 1, 4, 5, and 8.

Furthermore, projections 150 can have the repeating pattern as shown, for example, in FIG. 5 where apertures 152 in one row are offset in relation to the apertures 152 of an adjacent row. Alternatively, the projections 150 may form any other repeating pattern and apertures 152 in one row can be in-line with the apertures 152 of an adjacent row.

In operation, a roller assembly 100 according to the present invention may be used in the conventional manner. For example, the roller assembly 100 may be positioned opposite to a fixed anvil (not shown) or an opposing counter-rotating roller (not shown) to crush, compact, or shred materials fed to the roller 100. In some embodiments, the counter-rotating roller is also manufactured according to the present invention. Material fed into the roller 100 enters the nip, where the surface segments 130, either alone or in combination with projections 150, crush, shred, or compact material as it passes through the nip.

If the surface segments 130 are bolted in place, the surface segments 130 may be removed by extracting the bolts 145 from the hub holes 128 and bolt holes 146. If the surface segments 130 are glued in place or shrink-fit, the roller 100 or the segments 130 being removed may be heated to a sufficiently high temperature to destroy the glue or release the shrink-fitting. In any event, hammering may also be required to free the surface segments 130, particularly if the roller 100 has been fouled with dirt or ground material during its operation.

If the surface segments 130 also carry projections 150 such as studs, teeth, depressions, grooves, paddles, or blades, the replacement of the surface segments 130 also results in the replacement of the projections 150 on the roller 100. Accordingly, the remanufacture process can also be used when the projections 150 are worn, before the underlying surface segments 130 which carry them also become worn.

While the orientation of the apertures 152 and the corresponding projections 150 has been described in reference to a surface segment 130, the same orientation disposed directly on a roller 100 without a plurality of surface segments 130 is contemplated. Additionally, while the surface segments 130 have straight edges so that they are easily interconnected with sides 140, 1.42 corresponding with a cylindrical shaped hub 120, surface segments 130 appearing in any shape which may be interconnected to substantially cover a cylindrical shaped hub 120 are contemplated. Included within such shaped segments are the segments 130 which are the subject of a co-pending U.S. provisional application by CSP Innovative Engineering Ltd. entitled “Roller With Replaceable Surface Segments and Method of Reconditioning Same”, filed Feb. 19, 2014, which is incorporated herein by reference.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention except to the degree that such dimensions are reflected in any claims. The subject matter described herein and in the recited claims intends to cover and embrace all suitable changes in technology.

1-27. (canceled)

28. A roller for crushing, grinding, or otherwise contacting a material, the roller comprising:
a cylindrical body rotatable about a central axis, the body comprising:
a first and second opposed ends; and
a working surface disposed between the opposed sides, the working surface comprising:
a plurality of projections for crushing, grinding, or otherwise contacting a material, wherein the spacing of the projections across the working surface decreases from each of the opposed ends to an intermediate point between the opposed ends.

29. The roller of claim 28 wherein the spacing between adjacent projections proximate to at least one of the opposed ends is greater than the spacing between adjacent projections proximate to the intermediate point between the ends.

30. The roller of claim 28 wherein the projections form rows aligned with the central axis and each row spans the opposed ends.

31. The roller of claim 30 wherein the projections of one row are offset with the projections of an adjacent row.

32. The roller of claim 30 wherein along one row the spacing between adjacent projections proximate to at least one of the opposed ends is within a range between 28 millimeters and 32 millimeters and the spacing between adjacent projections proximate to the intermediate point between the ends is within a range between 25 millimeters and 27 millimeters.

33. The roller of claim 30 wherein along one row the spacing between adjacent projections proximate to at least one of the opposed ends is 30 millimeters and the spacing between adjacent projections proximate to the intermediate point between the ends is 26.32 millimeters.

34. A roller assembly for crushing, grinding, or otherwise contacting a material, the assembly comprising:
a hub configured for mounting to an axle, said hub rotating about a central axis and having an outer surface comprising one or more engagement structures; and
a plurality of surface segments configured for attaching to said one or more engagement structures of said hub, said segments each comprising:
an exterior surface for contacting material at a working surface of the roller assembly;
an interior surface opposed to said exterior surface configured to engage an engagement structure disposed on the outer surface of the hub, thereby covering at least a portion of the outer surface of the hub;
a leading edge and a trailing edge joining the exterior surface to the interior surface;
a first and second opposed sides joining the outer surface to the inner surface; and
a plurality of projections for crushing, grinding, or otherwise contacting a material, wherein the spacing of the projections across the exterior surface decreases from each of the opposed sides to an intermediate point between the opposed sides.

35. The assembly of claim 34 wherein the spacing between adjacent projections proximate to at least one of the opposed sides is greater than spacing between adjacent projections proximate to the intermediate point between the sides.

36. The assembly of claim 34 wherein the plurality of projections comprises rows of projections aligned with the central axis and each row spans the opposed sides.

37. The assembly of claim 36 wherein the projections of one row are offset with the projections of an adjacent row.

38. The assembly of claim 36 wherein along one row the distance between adjacent projections proximate to either sides is within a range between 28 millimeters and 32 millimeters and the distance between adjacent projections proximate to the intermediate point between the sides is within a range between 25 millimeters and 27 millimeters.

39. The assembly of claim 36 wherein along one row the distance between adjacent projections proximate to at least one of the opposed sides is 30 millimeters and the distance between adjacent projections proximate to the intermediate point between the sides is 26.32 millimeters.

40. The assembly of claim 34 wherein the spacing of the plurality of projections across the exterior surface decreases from at least one of the leading edge and the trailing edge to an intermediate point between the leading edge and the trailing edge.

41. The assembly claim 34 wherein a first angle subtended between adjacent projections proximate to at least one of the leading and trailing edge is greater than a second angle subtended between adjacent projections proximate to an intermediate point between the leading edge and the trailing edge.

42. The assembly of claim 41 where the first angle is about 0.01 degrees greater than the second angle.

43. A surface segment for the roller assembly of claim 34.

44. The assembly of claim 34 wherein the surface segments are removeably attachable to said one or more engagement structures of said hub.

45. A roller assembly for crushing, grinding, or otherwise contacting a material, the assembly comprising:
a hub configured for mounting to an axle, said hub having an outer surface comprising one or more engagement structures, and;
a plurality of surface segments configured for attaching to said one or more engagement structures of said hub, said segments each comprising:
an exterior surface for contacting material at a working surface of the roller assembly;
an interior surface opposed to said exterior surface of the surface segment configured to engage an engagement structure disposed on the outer surface of the hub, thereby covering at least a portion of the outer surface of the hub;
a leading edge and a trailing edge joining the outer surface to the inner surface;
a first and second opposed sides joining the outer surface to the inner surface; and
a plurality of projections for crushing, grinding, or otherwise contacting a material, wherein the spacing of the plurality of projections across the exterior surface decreases from each of the leading edge and the trailing edge to an intermediate point between the between the leading edge and the trailing edge.

46. The assembly claim 45 wherein a first angle subtended between adjacent projections proximate to at least one of the leading edge and the trailing edge is greater than a second angle subtended between adjacent projections proximate to an intermediate point between the leading edge and the trailing edge.

47. The assembly of claim 46 where the first angle is about 0.01 degrees greater than the second angle.
